(19) United States
(12) Patent Application Publication
(10) Pub. No.: US 2025/0175235 A1
(43) Pub. Date: May 29, 2025

(54) APPARATUS, SYSTEM, AND METHOD OF BEAMFORMING TRAINING OVER A MILLIMETERWAVE (MMWAVE) WIRELESS COMMUNICATION CHANNEL

(71) Applicant: INTEL CORPORATION, SANTA CLARA, CA (US)

(72) Inventors: Laurent Cariou, Milizac (FR); Cheng Chen, Camas, WA (US); Po-Kai Huang, San Jose, CA (US); Carlos Cordeiro, Portland, OR (US)

(73) Assignee: INTEL CORPORATION, SANTA CLARA, CA (US)

(21) Appl. No.: 18/842,838

(22) PCT Filed: Mar. 31, 2022
(86) PCT No.: PCT/US2022/022902

§ 371 Date: Aug. 30, 2024

(51) Int. Cl. H04B 7/06

(52) U.S. Cl. CPC H04B 7/06952

(57) ABSTRACT

For example, an AP device may be configured to transmit a beamforming training trigger frame from a sub-10 GHz AP of the AP device over a sub-10 GHz wireless communication channel, the beamforming training trigger frame including configuration information to configure beamforming training over a mmWave wireless communication channel; to transmit a sequence of training frames from a mmWave AP of the AP device over the mm Wave wireless communication channel after the beamforming training trigger frame, the sequence of training frames includes one or more sector-based training sequences according to the configuration information, wherein a sector-based training sequence includes transmission of one or more training frames according to the configuration information; and to process a feedback frame from a non-AP device to identify feedback information based on the sequence of training frames.

### TECHNICAL FIELD

Aspects described herein generally relate to beamforming training over a millimeterWave (mmWave) wireless communication channel.

### BACKGROUND

Devices in a wireless communication system may be configured to communicate a millimeterWave (mmWave) wireless communication channel. There is a need to provide a technical solution to support discovery and/or beamforming training over the mmWave wireless communication channel.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of a beamforming training procedure over an millimeterWave (mmWave) wireless communication channel, in accordance with some demonstrative aspects.

FIG. 5 is a schematic illustration of a beamforming training procedure over an mmWave wireless communication channel, in accordance with some demonstrative aspects.

FIG. 6 is a schematic illustration of a beamforming training procedure over an mmWave wireless communication channel, in accordance with some demonstrative aspects.

FIG. 7 is a schematic illustration of a beamforming training procedure over an mmWave wireless communication channel, in accordance with some demonstrative aspects.

FIG. 8 is a schematic flow-chart illustration of a method of beamforming training over an mmWave wireless communication channel, in accordance with some demonstrative aspects.

FIG. 9 is a schematic flow-chart illustration of a method of beamforming training over an mmWave wireless communication channel, in accordance with some demonstrative aspects.

FIG. 10 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December 2020); and/or IEEE 802.11be (IEEE P802.11be/D1.4 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), January 2022)) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by a mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHZ channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

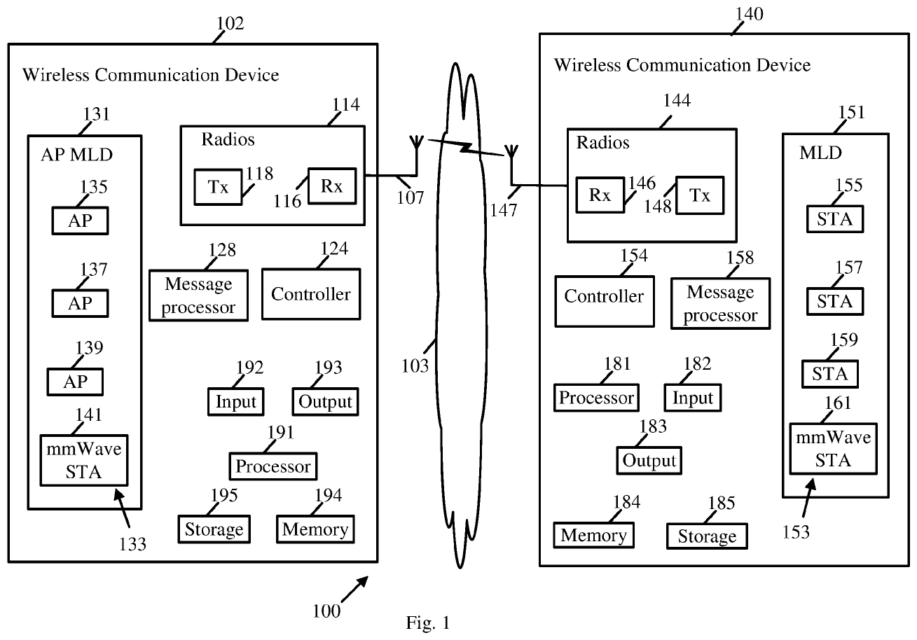

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102 and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device.

Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band.

In other aspects, WM 103 may include any other type of channel over any other frequency band.

In some demonstrative aspects, device 102 and/or device 140 may include one or more radios including circuitry and/or logic to perform wireless communication between devices 102, 140 and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 Ghz band, for example, 2.4 GHz band, a 5 GHz band, a 6 GHz band, and/or any other sub-10 GHz band; and/or an mmWave band, e.g., a 45 Ghz band, a 60 Ghz band. and/or any other mmWave band: and/or any other band, e.g., a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a plurality of, antennas 107, and/or device 140 may include on or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or more messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, device 102 and/or device 140 may include, operate as, perform the role of, and/or perform one or more functionalities of, one or more mmWave STAs, e.g., DMG STAs, EDMG STAs, and/or any other mmWave STA. For example, device 102 may include, operate as, perform the role of, and/or perform one or more functionalities of, one or more mmWave STAs, and/or device 140 may include, operate as, perform the role of, and/or perform one or more functionalities of, one or more mmWave STAs.

In other aspects, devices 102 and/or 140 may include, operate as, perform the role of, and/or perform one or more functionalities of, any other wireless device and/or station, e.g., a WLAN STA, a WiFi STA, and the like.

In some demonstrative aspects, device 102 and/or device 140 may be configured to operate as, perform the role of, and/or perform one or more functionalities of, an access point (AP), e.g., an EHT AP STA.

In some demonstrative aspects, device 102 and/or device 140 may be configured to operate as, perform the role of, and/or perform one or more functionalities of, a non-AP STA, e.g., an EHT non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF).The AP may perform any other additional or alternative functionality.

In some demonstrative aspects devices 102 and/or 140 may be configured to communicate in an EHT network, and/or any other network.

In some demonstrative aspects, devices 102 and/or 140 may be configured to operate in accordance with one or more Specifications, for example, including one or more IEEE 802.11 Specifications, e.g., an IEEE 802.11-2020 Specification, an IEEE 802.11be Specification, an IEEE 802.11ay Specification and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of service basic sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, perform and/or to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, a mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 Ghz band, as described below.

In some demonstrative aspects, for example, the one or more radios 114 may include, for example, a radio for communication by AP STA 137 over a second wireless communication frequency channel and/or frequency band, e.g., a 5 Ghz band, as described below.

In some demonstrative aspects, for example, the one or more radios 114 may include, for example, a radio for communication by AP STA 139 over a third wireless communication frequency channel and/or frequency band, e.g., a 6 Ghz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 45 Ghz, for example, a 6-GHz band or any other mmWave band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to control, perform and/or to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, perform and/or to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 Ghz band, as described below.

In some demonstrative aspects, for example, the one or more radios 144 may include, for example, a radio for communication by STA 157 over a second wireless communication frequency channel and/or frequency band, e.g., a 5 Ghz band, as described below.

In some demonstrative aspects, for example, the one or more radios 144 may include, for example, a radio for communication by STA 159 over a third wireless communication frequency channel and/or frequency band, e.g., a 6 Ghz band, as described below.

In some demonstrative aspects, for example, the one or more radios 144 may include, for example, a radio for communication by mmWave STA 161 over a fourth wireless communication frequency channel and/or frequency band, e.g., a mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, perform and/or to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, perform and/or to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to control, perform and/or to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

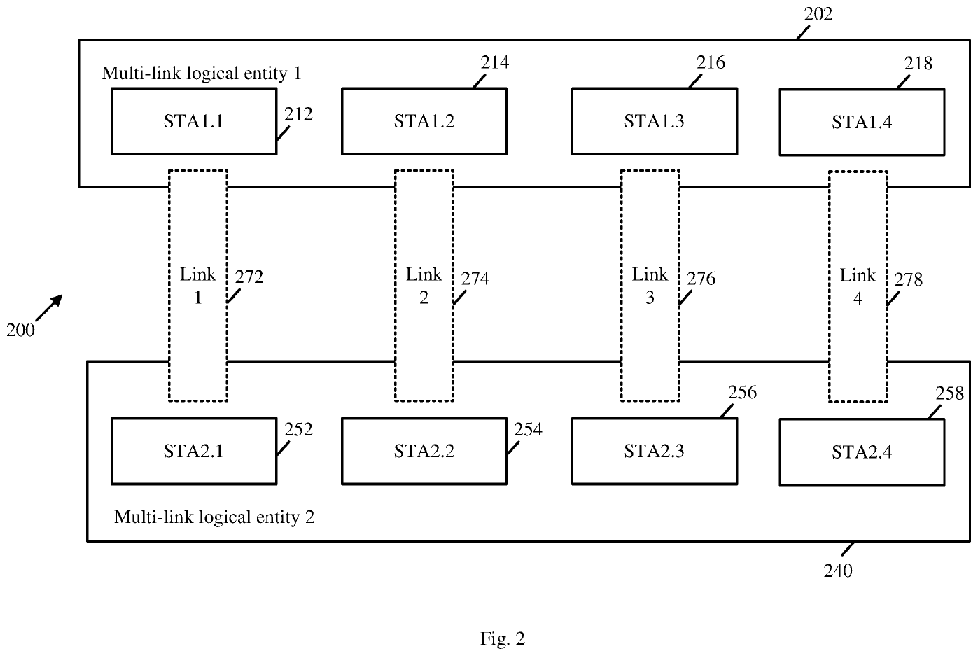

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

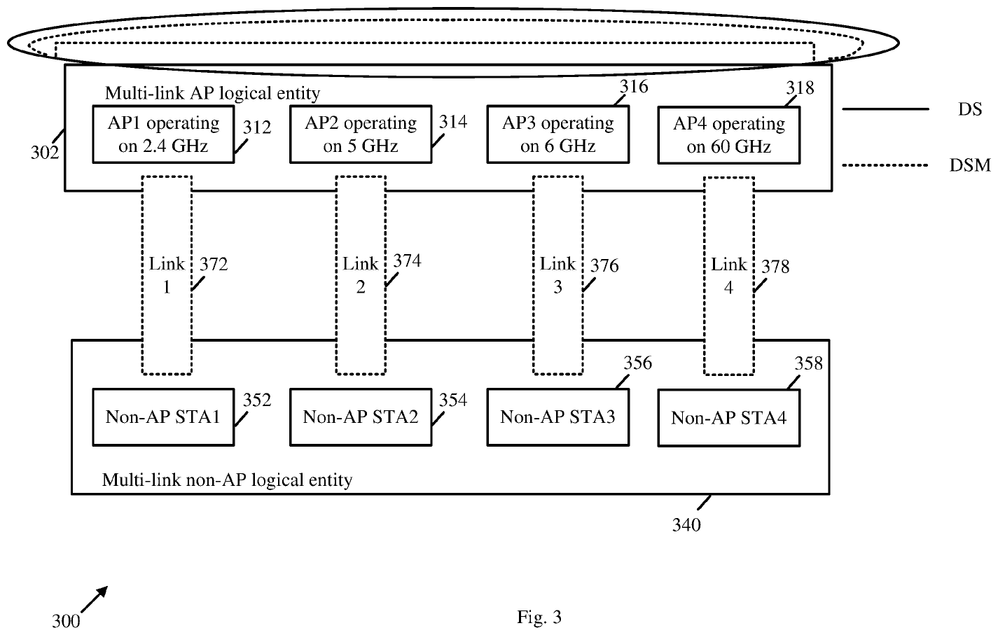

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 Ghz frequency band, AP STA 314 may be configured to communicate over a 5 Ghz frequency band, AP STA 316 may be configured to communicate over a 6 Ghz frequency band, and/or mmWave STA 318 may be configured to communicate over a mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, device 102 and/or device 140 may be configured to support a technical solution for communication between mmWave STAs, e.g., mmWave STA 141 and mmWave STA 161, over the mmWave frequency band, e.g., as described below.

In some demonstrative aspects, device 102 and/or device 140 may be configured to support a technical solution to utilize communications over the sub-10 GHz frequency band, for example, to assist one or more operations to be performed by the mmWave STAs, e.g., mmWave STA 141 and mmWave STA 161, over the mmWave frequency band, e.g., as described below.

In some demonstrative aspects, device 102 and/or device 140 may be configured to support a technical solution to utilize communications over the sub-10 GHz frequency band, for example, to assist a beamforming training procedure to be performed by the mmWave STAs, e.g., mmWave STA 141 and mmWave STA 161, over the mm Wave frequency band, e.g., as described below.

In some demonstrative aspects, device 102 and/or device 140 may be configured to provide a technical solution to support mmWave operation, e.g., operation at 60 GHz, together with and/or as part of a sub-10 Ghz functionality, for example, of a mainstream Wi-Fi, e.g., as described below

In some demonstrative aspects, device 102 and/or device 140 may be configured to support a technical solution, which may be based on and/or may utilize cost reduction of wireless communication architecture, which may allow to reuse at least some component of, e.g., as much as possible the same baseband, for a sub-10 GHz radio, e.g., a regular Wi-Fi radio, and a mmWave radio, e.g., a 60 GHz radio.

In some demonstrative aspects, device 102 and/or device 140 may be configured to support a technical solution, which may be based on and/or may utilize an enhanced throughput supported by mmWave techniques, e.g., compared to a sub-10 GHz band (lower band), which may have less potential for throughput enhancement.

In some demonstrative aspects, device 102 and/or device 140 may be configured to support a technical solution, which may be based on and/or may utilize a multi-link framework, e.g., as described below.

In some demonstrative aspects, device 102 and/or device 140 may be configured to utilize the multi-link framework, for example, to improve operation on multiple links. In one example, the multi-link framework may be utilized to allow compensating for a fragility of a mmWave link, e.g., a 60 GHz link, for example, through a fall back to the sub-10 GHz band (lower band) operation.

In some demonstrative aspects, there may be a need to provide a technical solution to define one or more main PHY characteristics for operation over the mmWave frequency band, e.g., at 60 GHz, for example, in order to reduce, e.g., minimize, a number of changes to a sub-10 GHz baseband (lower baseband) design.

In some demonstrative aspects, one or more main PHY characteristics may be defined for operation over the mmWave frequency band, e.g., at 60 GHz, for example, to provide a technical solution to support reusing one or more settings, e.g., most of the settings, of the sub-10 GHz band. In one example, upclocking may be implemented, for example, to adjust sub-10 Ghz characteristics to larger bandwidths at 60 GHz. In one example, subcarrier spacing may be increased, for example, to mitigate phase noise at 60 GHz.

In some demonstrative aspects, device 102 and/or device 140 may be configured to support a technical solution to define mmWave PHY characteristics, e.g., 60 GHz PHY characteristics, for example, based on, e.g., as resemblant as possible to, one or more PHY parameters in the sub-10 GHz band (lower band).

In some demonstrative aspects, device 102 and/or device 140 may be configured to utilize an upclocking mechanism, for example, to generate a PPDU transmission over the mmWave band by upclocking a PPDU transmission of the sub-10 GHz band. For example, upclocking the PPDU transmission may support reusing one or more, e.g., some or all, PHY components from the PHY layer for the sub-10 GHz band and the mmWave band. In one example, the upclocked PPDU may be generated by upclocking a PPDU transmission equivalent to a 3.2 microsecond (us) OFDM symbol, e.g., according to an IEEE 802.11 Specification. In one example, the PPDU transmission may be upclocked by a factor of 8 times, and/or any other factor.

For example, a beamforming procedure may be utilized in the mmWave band, e.g., at a transmitter direction and/or at a receiver direction, for example, to support a decent range for communications over the mmWave band. This beamforming procedure may not be required at the sub-10 GHz band.

For example, a beamforming procedure according to IEEE 802.11 Specifications, e.g., the IEEE 802.11ad Specification and/or the IEEE 802.11ay Specification, may be configured assuming a minimum beamforming training equivalent to a gain of 15 dB, e.g., on both transmit and receive directions.

For example, when a link is not established between an AP and a non-AP STA over the mmWave band, one or more initial beamforming training phases, e.g., according to the IEEE 802.11ad/ay Specifications, may be based on a transmitter side sending, e.g., the AP, training frames with a sector sweep. For example, the transmitter side may send multiple times the same training frame while transmitting each training frame with a different transmit beamforming pattern/sector. For example, the transmitter side may include in the training frame the sector ID that has been used for the transmission.

For example, the receiver side, e.g., the non-AP STA, may listen to the training phase, e.g., in an omni directional mode, and may try to detect transmissions from the AP.

For example, if the receiver side is able to lock its reception on one or more of the training frames, the receiver side may then measure a Received Signal Strength Indicator (RSSI), and associate the RSSI with the sector ID found in the frame.

For example, the receiver side may determine, e.g., at an end of a training sequence, which transmit sector ID was the best sector.

For example, in some variants, the training frame may include a training (TRN) sequence, e.g., at the end of the frame. For example, the TRN sequence may include a repetition of several training fields, for example, in order to support the receiver side in performing receive sector sweep and train its receive beamforming at the same time.

In some demonstrative aspects, in some use cases, scenarios and/or implementations, there may be a need to address one or more technical issues of these initial beamforming training phases, e.g., according to the IEEE 802.11ad/ay Specification. For example, these initial beamforming sequences, e.g., according to the

IEEE 802.11ad/ay Specifications, may be based on an assumption that it is possible to close the link and detect a transmission from one side to the other with only one side performing beamforming and the other side performing an omni transmit or receive, e.g., without beamforming. This assumption may require that the devices participating in the beamforming procedure are able to detect a signal with a sensitivity around 15 dB better. For example, a special PHY mode, e.g., a Control PHY mode, may be required in order to support this level of sensitivity. For example, the Control PHY mode may be defined as a single carrier PPDU transmission.

In some demonstrative aspects, device 102 and/or device 140 may be configured to implement a beamforming mechanism, which may be configured to provide a technical solution to support a simple design and/or to reuse encoding from a sub-10 GHz band, e.g., a lower band, e.g., as described below.

In some demonstrative aspects, device 102 and/or device 140 may be configured to implement a beamforming mechanism, which may be configured to support beamforming operation, for example, even without requiring a special PHY mode, e.g., for example, even without using the special control PHY mode, e.g., as described below.

For example, a gain of about 3/6 dB may be achieved, for example, if one of the sides of the beamforming training has a very small antenna array, e.g., including 2/4 antennas. For example, the gain of about 3/6 dB may be achieved using repetition tools from the lower band on an OFDM transmission, e.g., according to a Dual Carrier Modulation (DCM) mechanism. However, it may be hard to achieve this gain, for example, in case of a larger antenna array, e.g., including up to 64 or even more antennas.

In some demonstrative aspects, device 102 and/or device 140 may be configured to support a beamforming mechanism utilizing a beamforming sequence, which may be configured to support an initial beamforming training, e.g., even without using a control PHY and/or even for large antenna arrays, e.g., as described below.

In some demonstrative aspects, the beamforming mechanism may be configured to utilize triggering and/or coordination, for example, over the sub-10 GHz band, for example, to trigger and/or coordinate the beamforming training over the mmWave band, e.g., as described below.

In some demonstrative aspects, a STA implemented by device 140 and/or a STA implemented by device 102 may be configured to operate at 60 GHz, for example, as part of an MLD. For example, a 60 GHz STA/AP may be affiliated with a non-AP/AP MLD with at least another STA/AP operating in the sub-10 GHz band, e.g., one or more of the 2.4/5/6 GHz bands, as described above.

In some demonstrative aspects, the scope of the MLD mechanism may be extended, for example, such that the role of the AP at 60 GHz may be different than a regular AP, while still being a part of an AP MLD.

In some demonstrative aspects, a STA, e.g., a STA implemented by device 140, may be configured to perform an ML association/ML setup as a non-AP MLD with an AP MLD, e.g., an AP MLD implemented by device 102, that has an AP operating in the 60 GHz band, for example, in order to operate at the 60 GHz band. For example, the STA, e.g., a STA implemented by device 140, may include in the ML association/ML setup at least two links, for example, one at 60 GHz and one in the sub-10 GHz band, e.g., at a 2.4/5/6 GHz band. For example, the ML Discovery and/or the ML association may be performed over the sub-10 GHz link.

In some demonstrative aspects, device 102 and/or device 140 may be configured to perform a beamforming training procedure over an mmWave wireless communication channel assisted by communications over a sub-10 GHz wireless communication channel, e.g., as described below.

In some demonstrative aspects, controller 124 may be configured to control, trigger, cause, and/or instruct an AP device implemented by device 102 to transmit a beamforming training trigger frame from a sub-10 GHz AP of the AP device over a sub-10 GHz wireless communication channel, e.g., as described below.

In some demonstrative aspects, the beamforming training trigger frame may configuration information to configure beamforming training over a mmWave wireless communication channel, e.g., as described below.

In some demonstrative aspects, the configuration information may include a first count value to indicate a count of transmit sectors to be used by the AP device, e.g., as described below.

In some demonstrative aspects, the configuration information may include a second count value to indicate a count of training frames per transmit sector, e.g., as described below.

In some demonstrative aspects, controller 124 may be configured to control, trigger, cause, and/or instruct the AP device implemented by device 102 to transmit a sequence of training frames from a mmWave AP of the AP device, e.g., mmWave AP 141, over the mmWave wireless communication channel, for example, after the beamforming training trigger frame, e.g., as described below.

In some demonstrative aspects, the sequence of training frames may be configured to include one or more sector-based training sequences, for example, according to the first count value, e.g., as described below.

In some demonstrative aspects, a sector-based training sequence may be configured to include transmission of one or more training frames, for example, according to the second count value, e.g., as described below.

In some demonstrative aspects, controller 124 may be configured to control, trigger, cause, and/or instruct the mmWave AP implemented by device 102, e.g., mmWave STA 141, to transmit the sequence of training frames according to a data PHY mode configured for data communication over the mmWave wireless communication channel, e.g., as described below.

In some demonstrative aspects, the data PHY mode may include a Single Carrier (SC) PHY mode, e.g., as described below.

In some demonstrative aspects, the data PHY mode may include an Orthogonal Frequency-Division Multiplexing (OFDM) PHY mode, e.g., as described below.

In other aspects, the data PHY mode may to include any other additional or alternative type of data PHY mode.

In some demonstrative aspects, the data PHY mode may include a PHY mode utilizing a Modulation and Coding Scheme (MCS) with an MCS index greater than 0. For example, the MCS index may include a value of 1, 2, or any other additional or alternative value.

In some demonstrative aspects, the sub-10 GHz wireless communication channel may include a sub-7 GHz channel. In other aspects, any other sub-10 GHz wireless communication channel may be used.

In some demonstrative aspects, the mmWave wireless communication channel may include a 60 GHz channel. In other aspects, any other mmWave wireless communication channel may be used.

In some demonstrative aspects, controller 124 may be configured to control, trigger, cause, and/or instruct the AP device implemented by device 102 to process a feedback frame from a non-AP device to identify feedback information, for example, based on the sequence of training frames, e.g., as described below.

In some demonstrative aspects, the feedback frame may be received by the sub-10 GHz AP over the sub-10 GHz wireless communication channel, e.g., as described below.

In some demonstrative aspects, the first count value may be greater than one, and the sequence of training frames may include a plurality of sector-based training sequences, e.g., as described below.

In some demonstrative aspects, a count of sector-based training sequences in the plurality of sector-based training sequences may be equal to the first count value, e.g., as described below.

In some demonstrative aspects, the second count value may be based on a count of receive sectors of the non-AP device, e.g., as described below.

In other aspects, the second count value may be based on any other additional or alternative parameter and/or criteria.

In some demonstrative aspects, the second count value may be greater than one, and the sector-based training sequence may include transmission of a plurality of training frames, e.g., as described below.

In some demonstrative aspects, a count of training frames in the plurality of training frames may be equal to the second count value, e.g., as described below.

In other aspects, the first count value and/or the second count value may be configured according to any other setting and/or criteria.

In some demonstrative aspects, the configuration information may include timing information to indicate a target sequence start time of a beginning of the sequence of training frames, e.g., as described below.

In some demonstrative aspects, controller 124 may be configured to control, trigger, cause, and/or instruct the mmWave AP implemented by device 102, e.g., mmWave STA 141, to access the mmWave wireless communication channel for transmission of the sequence of training frames, for example, based on the timing information, e.g., as described below.

In some demonstrative aspects, controller 124 may be configured to control, trigger, cause, and/or instruct the mmWave AP implemented by device 102, e.g., mmWave STA 141, to begin transmission of a training frame of the sequence of training frames, for example, within a start time margin relative to a target training frame start time, e.g., as described below.

In some demonstrative aspects, the target training frame start time may be based on the target sequence start time, e.g., as described below.

In other aspects, the target training frame start time may be based on any other additional or alternative parameter.

In some demonstrative aspects, controller 124 may be configured to control, trigger, cause, and/or instruct the mmWave AP implemented by device 102, e.g., mmWave STA 141, to begin the sequence of training frames at a delayed sequence start time, for example, based on a determination that a start time of the sequence of training frames is to be delayed relative to the target sequence start time, e.g., as described below.

In some demonstrative aspects, the delayed sequence start time may be based on the target sequence start time, a training frame duration, and/or a start time margin, e.g., as described below.

In some demonstrative aspects, the delayed sequence start time may be based on a sum of the target sequence start time, an integer multiple of the training frame duration, and the start time margin, e.g., as described below.

In other aspects, the delayed sequence start time may be based on any other additional or alternative parameter.

In some demonstrative aspects, controller 124 may be configured to control, trigger, cause, and/or instruct the mmWave AP implemented by device 102, e.g., mmWave STA 141, to begin the sequence of training frames with a first-in-order training frame of an ordered training frame sequence, for example, when a start time of the sequence of training frames is at a delayed start time, which is delayed relative to the target sequence start time, e.g., as described below.

In some demonstrative aspects, the ordered training frame sequence may be configured for transmission at the target sequence start time, e.g., as described below.

In some demonstrative aspects, controller 124 may be configured to control, trigger, cause, and/or instruct the mmWave AP implemented by device 102, e.g., mmWave STA 141, to begin the sequence of training frames with a non-first-in-order training frame of the ordered training frame sequence, for example, based on a determination that a start time of the sequence of training frames is at a delayed start time, which is delayed by a delay period relative to the target sequence start time, e.g., as described below.

In some demonstrative aspects, the non-first-in-order training frame may include an (X+1) training frame of the ordered training frame sequence, wherein X denotes a count of training frame durations in the delay period, e.g., as described below.

In some demonstrative aspects, controller 124 may be configured to control, trigger, cause, and/or instruct the mmWave AP implemented by device 102, e.g., mmWave STA 141, to transmit one or more first training frames, e.g., X first training frames, of the ordered training frame sequence, for example, after transmission of a last training frame of the ordered training frame sequence, e.g., as described below.

In some demonstrative aspects, a training frame of a sector-based training sequence via a transmit sector may be configured to include a sector identifier (ID) to identify the transmit sector, e.g., as described below.

In some demonstrative aspects, a training frame of the sequence of training frames may be configured to include a target sequence end time to indicate an end time of the sequence of training frames, e.g., as described below.

In some demonstrative aspects, the configuration information my include sequence duration information to indicate a total duration of the sequence of training frames, e.g., as described below.

In some demonstrative aspects, the configuration information may include training frame duration information to indicate a duration of a training frame in the sequence of training frames, e.g., as described below.

In some demonstrative aspects, the configuration information may include listening duration information to indicate a total listening duration during which the non-AP device is to listen for the sequence of training frames over the mmWave wireless communication channel, e.g., as described below.

In some demonstrative aspects, the total listening duration may be longer than a total duration of the sequence of training frames, e.g., as described below.

In some demonstrative aspects, an inter-training frame time interval between consecutive training frames in the sector-based training sequence may be based on a sector switching time of the non-AP device, e.g., as described below.

In some demonstrative aspects, controller 154 may be configured to control, trigger, cause, and/or instruct a non-AP device implemented by device 140 to process a beamforming training trigger frame from an AP device, e.g., as described below.

In some demonstrative aspects, controller 154 may be configured to control, trigger, cause, and/or instruct a sub-10 GHz non-AP STA implemented by device 140, e.g., STA 155, to receive the beamforming training trigger frame over a sub-10 GHz wireless communication channel, e.g., as described below.

For example, device 102 and/or device 140 may be configured to communicate the beamforming training trigger frame over the sub-10 GHz wireless communication channel. For example, device 102 may transmit the beamforming training trigger frame to device 140; and/or device 140 may receive the beamforming training trigger frame from device 102.

In some demonstrative aspects, the beamforming training trigger frame may include configuration information to configure beamforming training over a mmWave wireless communication channel, e.g., as described below.

In some demonstrative aspects, controller 154 may be configured to control, trigger, cause, and/or instruct a non-AP device implemented by device 140 to identify in the configuration information a first count value to indicate a count of transmit sectors to be used by the AP device, and/or a second count value to indicate a count of training frames per transmit sector e.g., as described below.

In some demonstrative aspects, controller 154 may be configured to control, trigger, cause, and/or instruct the non-AP device implemented by device 140 to operate a mmWave non-AP STA of the non-AP device, e.g., mmWave STA 161, to receive from the AP device one or more training frames of a sequence of training frames over the mm Wave wireless communication channel, for example, based on the beamforming training trigger frame, e.g., as described below.

In some demonstrative aspects, the sequence of training frames may include one or more sector-based training sequences according to the first count value, e.g., as described below.

In some demonstrative aspects, a sector-based training sequence may include one or more training frames according to the second count value, e.g., as described below.

In some demonstrative aspects, the second count value may be based on a count of receive sectors of the non-AP device implemented by device 140, e.g., as described below.

In some demonstrative aspects, the first count value may be greater than one, for example, 2 or 3 or any other additional or alternative value.

In some demonstrative aspects, the sequence of training frames may be configured to include a plurality of sector-based training sequences, e.g., as described below.

In some demonstrative aspects, a count of sector-based training sequences in the plurality of sector-based training sequences may be equal to the first count value, e.g., as described below.

In some demonstrative aspects, the second count value may be greater than one, for example, 2 or 3 or any other additional or alternative value.

In some demonstrative aspects, the sector-based training sequence may be configured to include a plurality of training frames, e.g., as described below.

In some demonstrative aspects, the count of training frames in the plurality of training frames may be equal to the second count value, e.g., as described below.

In some demonstrative aspects, controller 154 may be configured to control, trigger, cause, and/or instruct the non-AP device implemented by device 140 to transmit a feedback frame to the AP device, e.g., as described below.

In some demonstrative aspects, controller 154 may be configured to control, trigger, cause, and/or instruct the sub-10 GHz non-AP STA implemented by device 140, e.g., STA 155, to transmit the feedback frame to the AP device over the sub-10 GHz wireless communication channel, e.g., as described below.

In some demonstrative aspects, the feedback frame may include feedback information, for example, based on the one or more training frames, e.g., as described below.

In some demonstrative aspects, controller 154 may be configured to control, trigger, cause, and/or instruct the non-AP device implemented by device 140 to sequentially switch between receive sectors of device 140, for example, based on the first count value and/or the second count value, e.g., as described below.

In some demonstrative aspects, controller 154 may be configured to control, trigger, cause, and/or instruct the non-AP device implemented by device 140 to identify a target sequence start time of a beginning of the sequence of training frames, for example, based on timing information in the configuration information, e.g., as described below.

In some demonstrative aspects, controller 154 may be configured to control, trigger, cause, and/or instruct the non-AP device implemented by device 140 to begin a receive sector switching sequence between receive sectors of device 140, for example, based on the target sequence start time, e.g., as described below.

In some demonstrative aspects, controller 154 may be configured to control, trigger, cause, and/or instruct the non-AP device implemented by device 140 to repeat the receive sector switching sequence, for example, based on the first count value, e.g., as described below.

In some demonstrative aspects, controller 154 may be configured to control, trigger, cause, and/or instruct the non-AP device implemented by device 140 to switch from a first receive sector to a second receive sector, for example, based on a training frame duration of a training frame in the sequence of training frames, e.g., as described below.

In some demonstrative aspects, controller 154 may be configured to control, trigger, cause, and/or instruct the non-AP device implemented by device 140 to switch from a first receive sector to a second receive sector, for example, during an inter-training frame time interval between first and second consecutive training frames of the sequence of training frames, e.g., as described below.

In some demonstrative aspects, controller 154 may be configured to control, trigger, cause, and/or instruct the non-AP device implemented by device 140 to identify a transmit sector of a received training frame, for example, based on a sector ID in the received training frame, e.g., as described below.

In some demonstrative aspects, controller 154 may be configured to control, trigger, cause, and/or instruct the non-AP device implemented by device 140 to identify an end time of the sequence of training frames, for example, based on a target sequence end time in a received training frame, e.g., as described below.

In some demonstrative aspects, controller 154 may be configured to control, trigger, cause, and/or instruct the non-AP device implemented by device 140 to identify a total duration of the sequence of training frames, for example, based on sequence duration information in the configuration information, e.g., as described below.

In some demonstrative aspects, controller 154 may be configured to control, trigger, cause, and/or instruct the non-AP device implemented by device 140 to identify a duration of a training frame in the sequence of training frames, for example, based on training frame duration information in the configuration information, e.g., as described below.

In some demonstrative aspects, controller 154 may be configured to control, trigger, cause, and/or instruct the non-AP device implemented by device 140 to identify a total listening duration, for example, based on listening duration information in the configuration information, e.g., as described below.

In some demonstrative aspects, controller 154 may be configured to control, trigger, cause, and/or instruct the non-AP device implemented by device 140 to operate the mmWave non-AP STA, e.g., mmWave STA 161, to listen for the sequence of training frames over the mmWave wireless communication channel during the total listening duration, e.g., as described below.

In some demonstrative aspects, the total listening duration may be longer than a total duration of the sequence of training frames.

In other aspects, any other total listening duration may be defined.

In some demonstrative aspects, controller 154 may be configured to control, trigger, cause, and/or instruct the mmWave non-AP STA implemented by device 140, e.g., mmWave STA 161, to process the sequence of training frames, for example, according to a data PHY mode configured for data communication over the mmWave wireless communication channel, e.g., as described below.

In some demonstrative aspects, the data PHY mode may include a SC PHY mode, or an OFDM PHY mode, e.g., as described below.

In some demonstrative aspects, the data PHY mode may include a PHY mode utilizing a MCS with an MCS index greater than 0, e.g., 1 or 2 or any other additional or alternative MCS index.

In other aspects, the data PHY mode may include any other additional or alternative PHY mode.

In some demonstrative aspects, device 102 and/or device 140 may be configured to implement operations of a beamforming training procedure, e.g., as described below.

In some demonstrative aspects, the beamforming training procedure may include communication of a beamforming training trigger frame, e.g., from a beamforming initiator to a beamforming responder, over the sub-10 GHz wireless communication channel; communication of a sequence of training frames, e.g., from the beamforming initiator to the beamforming responder; over the mmWave wireless communication channel, and/or communication a feedback frame, e.g., from the beamforming responder to the beamforming responder, e.g., as described below.

In some demonstrative aspects, the beamforming training procedure may be configured to include one or more phases, for example, three phases, e.g., as described below.

In other aspects, the beamforming training procedure may be configured to include any other additional or alternative phases.

In some demonstrative aspects, the beamforming initiator (AP/initiator), e.g., the AP device implemented by device 102, may be configured to transmit a Beamforming Training trigger frame in the sub-10 GHz band to the beamforming responder (STA/responder), e.g., the non-AP device implemented by device 140, for example, during a first phase of the beamforming training procedure, e.g., as described below.

In some demonstrative aspects, the beamforming training trigger frame may include an indication of a start time of the training sequence at 60 GHz, a number of sectors, denoted N, on the transmit/initiator side, and/or a number of sectors, denoted M, on the receive/responder side.

In some demonstrative aspects, the beamforming training trigger frame may include, e.g., optionally, an indication of the duration of the total training sequence, and/or a duration of each training frame, e.g., with an inter-training frame time interval.

In some aspects, the inter-training frame time interval may not be predefined, e.g., to allow using different inter-training frame time intervals. According to these aspects, the beamforming training trigger frame may be configured to indicate the inter-training frame time interval to be used for the beamforming training.

In other aspects, the inter-training frame time interval may be preconfigured. For example, it may be defined that the same predefined inter-training frame time interval may be used for all beamforming procedures.

In some demonstrative aspects, the beamforming training trigger frame may include, e.g., optionally, a mandatory listen duration which is longer than the total training sequence. For example, the listen duration may be used in case the start time of the sequence is delayed, e.g., because of channel access at 60 GHz.

In some demonstrative aspects, the AP/initiator, e.g., the AP device implemented by device 102, may be configured to transmit multiple training frames, for example, during a second phase of the beamforming training procedure, e.g., as described below.

In some demonstrative aspects, the AP/initiator, e.g., the AP device implemented by device 102, may be configured to transmit multiple training frames, e.g., back to back and separated by an inter-training frame time interval, for example, in order to support both transmit and receive sector sweep, for example, without requiring reception of a frame in omni direction mode.

In one example, the AP/initiator, e.g., the AP device implemented by device 102, may be configured to send M training frames, e.g., in accordance with the count value M indicated by the beamforming training trigger frame. For example, the AP/initiator, e.g., the AP device implemented by device 102, may be configured to send the M training frames utilizing each transmit sector, and including in the training frame the transmit sector ID.

In some demonstrative aspects, the STA/responder, e.g., the non-AP device implemented by device 140, may be configured to determine the start time of the transmission of each training frame and/or an ID of planned sector of a training frame, e.g., each training frame, for example, based on the start time of the training sequence and/or the sum of the duration of each training frame and the inter-training frame time interval.

In some demonstrative aspects, the STA/responder, e.g., the non-AP device implemented by device 140, may be configured to use a different receive beamforming sector on each training frame, e.g., by basically doing a receive sector sweep, for example, based on the knowledge of the start time of the transmission of each training frame and the ID of the planned sector of each training frame.

In one example, device 140, the STA/responder, e.g., the non-AP device implemented by device 140, may be configured to utilize the inter-training frame time interval to change between receive beamforming sectors of the STA/responder. For example, the inter-training frame time interval may be configured, for example, to allow enough time for the transmitter side and/or the receiver side to change between sectors, and to reach a stable transmission/reception.

In some demonstrative aspects, the second beamforming phase nay be performed by the STA/responder as a sort of “blind” receive sector sweep, for example, as the STA/responder may not receive at the 60 GHz band a signal that indicates that the sequence of training frames has started.

In some demonstrative aspects, the STA/responder, e.g., the non-AP device implemented by device 140, may be configured to transmit to the AP device a beamforming training feedback in the sub-10 GHz band, for example, during a third phase of the beamforming training procedure, e.g., as described below.

In some demonstrative aspects, the beamforming training feedback may include an indication of best transmit sectorID, an RSSI corresponding to the best transmit sectorID, and/or an indication of a best receive sectorID. In other aspects, the beamforming training feedback may include any other additional or alternative information.

In some demonstrative aspects, the STA/responder, e.g., the non-AP device implemented by device 140, may be configured to transmit the beamforming training feedback, for example, by accessing the medium with an Enhanced Distributed Channel Access (EDCA), and/or by being triggered by AP/initiator, for example, with a dedicated trigger frame.

In some demonstrative aspects, the second phase of the beamforming training procedure may be configured to provide a technical solution to be resilient to possible delay and/or advance of the target sequence start time, for example, due to channel access at 60 GHz, e.g., as described below.

In some demonstrative aspects, the beamforming procedure may be configured to define that the AP/initiator, e.g., the AP device implemented by device 102, is to start the sequence of training frames, for example, in order to ensure that a training frame, e.g., each training frame, of the sequence of training frames is to be transmitted within a start time margin relative to a target training frame start time. For example, the AP/initiator, e.g., the AP device implemented by device 102, may be configured to a training frame, e.g., each training frame, of the sequence of training frames at a timing, which is between a min start time and a max start time, e.g., as may be defined by target start time+−start time margin.

In some demonstrative aspects, the start time margin may be preconfigured and/or defined, for example, in accordance with a Specification or protocol.

In some demonstrative aspects, the start time margin may be advertised by the AP device and/or the non-AP STA.

In some demonstrative aspects, for example, in some cases, the AP device may miss the target sequence start time, which may be advertised in the beamforming training trigger frame sent to the non-AP device over the sub-10 GHz wireless communication channel, for example, due to channel access at 60 GHz.

In some demonstrative aspects, the AP/initiator, e.g., the AP device implemented by device 102, may be configured to align a start of the sequence of training frames within the start time margin on a subsequent training frame start time, for example, when the AP device acquires, e.g., finally acquires, channel access at 60 GHz at a later time.

In some demonstrative aspects, the STA/responder, e.g., the non-AP device implemented by device 140, may be configured to start a receive (Rx) sector sweep, for example, at the target sequence start time, for example, using parameters time provided in the Beamforming Training trigger frame, e.g., the parameters indicating number of receive sectors M, the number of transmit sectors N, and/or the target sequence start time.

In some demonstrative aspects, the STA/responder, e.g., the non-AP device implemented by device 140, may be configured to continue the Rx beamforming sector sweep, for example, for a duration, e.g., a listening duration, that is longer than the training sequence duration For example, the listening duration may be configured to provide a technical solution to support the STA/responder to receive all possible combinations of Tx and/or Rx sectors, e.g., in case an exact sequence start time on the AP/initiator side is delayed compared to the planned target sequence start time.

For example, in case the AP/initiator starts the sequence of training frames with a delay, the AP/initiator may also complete the sequence of training frames at a later time. For example, the receiver may still have the opportunity to go over all possible Tx/Rx sector sweep configurations and get a complete training, for example, even in case the sequence of training frames ends sooner than the time defined by the planned sequence start time+listen duration.

In some demonstrative aspects, the AP/initiator, e.g., the AP device implemented by device 102, may be configured to include in a training frame, e.g., in each transmitted training frame, a new target end time of the training sequence of training frames, for example, in case the AP device adjusts the target end time of the sequence of training frames, e.g., due to a delayed target sequence start time.

In some demonstrative aspects, the non-AP device, e.g., the STA/responder, may be able to know, e.g., exactly, when the sequence of training frames ends, and may adjust an end time of the Rx beamforming training, for example, when the non-AP device detects a new target end time of the sequence of training frames in one or more of the training frames, e.g., before the end of the sequence of training frames. For example, the adjusted an end time of the Rx beamforming training may possibly exceed the listening duration indicated in the Beamforming Training Trigger.

In some demonstrative aspects, the AP/initiator, e.g., the AP device implemented by device 102, may be configured to utilize one or more mechanisms to transmit the sequence of training frames, for example, in case of a sequence delay, where the start of the sequence is delayed by one or more frame durations, by a delay duration of X training frames, e.g., as described below.

In some demonstrative aspects, for example, according to a first option, the AP/initiator, e.g., the AP device implemented by device 102, may be configured to start the sequence of training frames with a first-in-order sector, e.g., a sector ID1, and with M repetitions, for example, as if the AP device was starting the sequence of training frames in time, e.g., without the delay. This first option may provide a technical solution, which may be relatively simple for implementation, e.g., on the AP/initiator side.

In some demonstrative aspects, the STA/responder, e.g., the receiver side, may be able to stay active longer in the Rx sector sweep mode, e.g., by exceeding the listening duration as defined above, for example, to still be able to experience all sector combinations, for example, even in case a disconnect between transmit and receive sector sweep may occur.

In some demonstrative aspects, for example, according to a first option, the AP/initiator, e.g., the AP device implemented by device 102, may be configured to start the sequence of training frames with an X+1-th training frame, for example, a frame immediately successive to the missed X training frames of the originally planned sequence.

In some demonstrative aspects, for example, according to a first option, the AP/initiator, e.g., the AP device implemented by device 102, may be configured to continue with transmitting the first X training frames, for example, at the end of the planned sequence of training frames, e.g., as described below.

In some demonstrative aspects, the second option may be implemented to provide a technical solution to preserve the alignment between Tx and Rx sector sweep, e.g., at the cost of a slight complexity increase on the Tx side, e.g., the AP/initiator side.

In some demonstrative aspects, the beamforming training procedure may be configured to allow the non-AP STA, e.g., device 140, and/or the AP, e.g., device 102, to perform a beamforming sequence, e.g., an additional beamforming sequence, by configuring the non-AP STA to perform the role of the initiator and/or the AP to perform the role of the responder during the second phase of the beamforming procedure. For example, this beamforming procedure may be implemented to support beamforming training in an opposite direction between the non-AP STA and the AP, for example, in case the AP and the non-AP STA do not have reciprocal beamforming.

In some demonstrative aspects, when implementing the additional beamforming sequence, the first phase of the beamforming training procedure may be left unchanged, for example, as the first phase of the beamforming training procedure may be scheduled by the AP.

In some demonstrative aspects, trigger frame may be configured to include an indication whether the AP device or the non-AP device is to perform the role of the transmitter in the second phase of the beamforming training procedure.

In some demonstrative aspects, is the third phase of the beamforming training procedure may include transmitting a feedback frame from the AP device to the non-AP device.

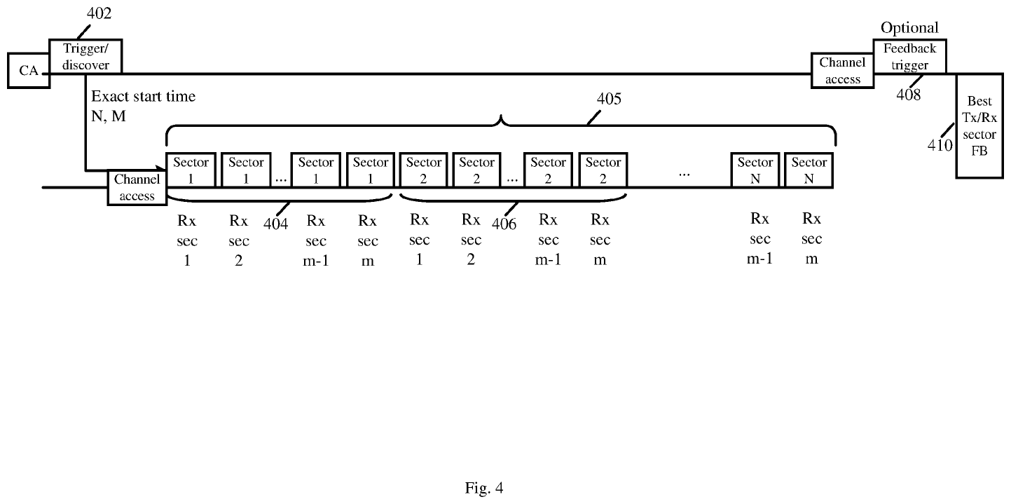

Reference is made to FIG. 4, which schematically illustrates a beamforming training procedure over an mmWave wireless communication channel, in accordance with some demonstrative aspects.

In some demonstrative aspects, as shown in FIG. 4, one or more operations and/or communications of the procedure of FIG. 4 may be performed between an AP device including a sub-10 Ghz AP and an mmWave AP, and a non-AP device including a sub-10 Ghz non-AP STA and an mmWave non-AP STA. For example, controller 124 (FIG. 1) may be configured to control, trigger, and/or cause the AP device implemented by device 102 (FIG. 1) to perform a role of, one or more operations of, and/or one or more functionalities of, the AP device including the sub-10 Ghz AP and the mmWave AP; and/or controller 154 (FIG. 1) may be configured to control, trigger, and/or cause the non-AP device implemented by device 140 (FIG. 1) to perform a role of, one or more operations of, and/or one or more functionalities of, the non-AP device including the sub-10 Ghz non-AP STA and the mmWave non-AP STA.

In some demonstrative aspects, the AP device and the non-AP device may have a link established in a sub-7 GHz band, and may intend to establish a 60 GHz link as well.

In some demonstrative aspects, the AP device and the non-AP device may perform one or more operations configured to trigger 60 GHz discovery and initial beamforming, e.g., as described below.

In some demonstrative aspects, as shown in FIG. 4, a frame exchange, e.g., including a beamforming training trigger frame 402, a sequence of training frames 405, and/or a feedback frame 410, may be performed between the two devices, during which capabilities and/or operating parameters related to 60 GHz operation may be exchanged.

In some demonstrative aspects, as shown in Fig. 4, the start of the discovery and initial beamforming, e.g., in the 60 GHz band, may be “triggered”, for example, by the AP device, e.g., using a trigger frame 402.

In some demonstrative aspects, the AP device implemented by device 102 (FIG. 1) may be configured to generate and/or transmit the beamforming training trigger frame 402. For example, device 102 (FIG. 1) may be configured to transmit the beamforming training trigger frame 402 from the sub-10 GHz AP of device 102 (FIG. 1) over a sub-10 GHz wireless communication channel.

In some demonstrative aspects, the non-AP device implemented by device 140 (FIG. 1) may be configured to receive and/or process the beamforming training trigger frame 402. For example, device 140 (FIG. 1) may be configured to receive beamforming training trigger frame 402 at the sub-10 GHz non-AP STA of device 140 (FIG. 1) over the sub-10 GHz wireless communication channel.

In some demonstrative aspects, the beamforming training trigger frame 402 may be configured to communicate, e.g., over the sub-7 GHz link, configuration information to configure the beamforming training procedure over a mmWave wireless communication channel, e.g., as described below.

In some demonstrative aspects, the beamforming training trigger frame 402 may be configured to indicate, signal, set and/or negotiate one or more parameters to configure the beamforming training procedure over the mmWave wireless communication channel, e.g., as described below.

In some demonstrative aspects, the configuration information may include a first count value to indicate a count of transmit sectors to be used by device 102 (FIG. 1), and a second count value to indicate a count of training frames per transmit sector.

In some demonstrative aspects, the configuration information may include timing information to indicate a target sequence start time of a beginning of the sequence of training frames 405.

In some demonstrative aspects, as shown in FIG. 4, the configuration information may include the number of transmit sectors N, the number of receive sectors M, and/or a start time, e.g., an exact start time, of the beginning of the sequence of training frames 405.

In some demonstrative aspects, the mmWave AP of device 102 (FIG. 1) may be configured to access the mmWave wireless communication channel for transmission of the sequence of training frames 405, for example, based on the timing information indicating the target sequence start time of the beginning of the sequence of training frames 405.

In some demonstrative aspects, as shown in FIG. 4, the mmWave AP of device 102 (FIG. 1) may be able to access the mmWave wireless communication channel for transmission of the sequence of training frames 405, for example, at the exact start time, e.g., without a delay.

In some demonstrative aspects, device 102 (FIG. 1) may be configured to transmit the sequence of training frames 405 from the mmWave AP of device 102 (FIG. 1) over the mmWave wireless communication channel, for example, after the beamforming training trigger frame 402.

In some demonstrative aspects, the sequence of training frames 405 may include one or more sector-based training sequences, for example, according to the first count value.

In some demonstrative aspects, as shown in FIG. 4, the sequence of training frames 405 may include N sector-based training sequences.

In some demonstrative aspects, as shown in FIG. 4, the sequence of training frames 405 may include a sector-based training sequence 404 corresponding, for example, to a first transmit sector; and a sector-based training sequence 406 corresponding, for example, to a second transmit sector.

In some demonstrative aspects, a sector-based training sequence may include transmission of one or more training frames, for example, according to the second count value.

For example, as shown in FIG. 4, each sector-based training sequence may include transmission of M training frames.

In some demonstrative aspects, as shown in FIG. 4, device 102 (FIG. 1) may be configured to optionally transmit a feedback trigger frame 408, for example, to trigger a feedback frame 410 from device 140 (FIG. 1).

In some demonstrative aspects, as shown in FIG. 4, device 102 (FIG. 1) may be configured to receive the feedback frame 410 from device 140 (FIG. 1) at the sub-10 GHz AP over the sub-10 GHz wireless communication channel.

In some demonstrative aspects, device 102 (FIG. 1) may be configured to process a feedback frame 410 from device 140 (FIG. 1) to identify feedback information, for example, based on the sequence of training frames 405.

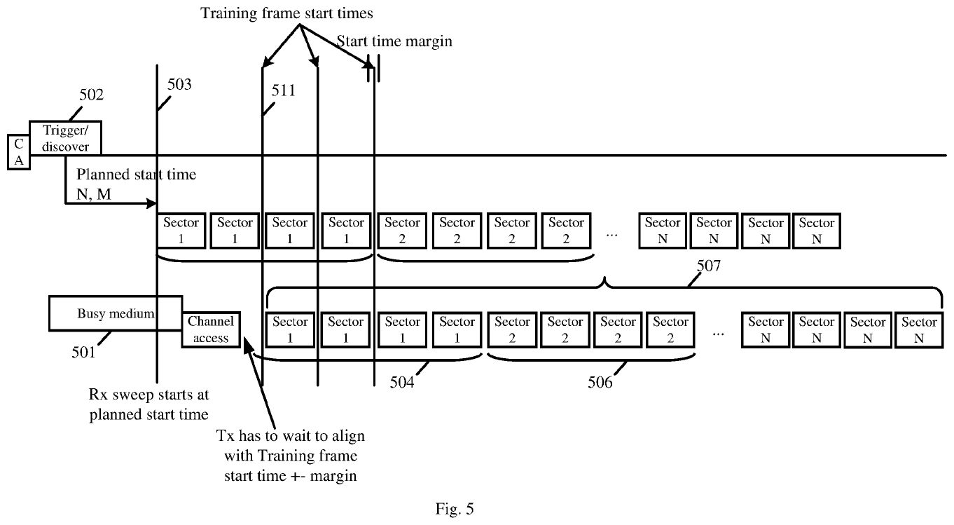

Reference is made to FIG. 5, which schematically illustrates a beamforming training procedure over an mmWave wireless communication channel, in accordance with some demonstrative aspects.

In some demonstrative aspects, as shown in FIG. 5, one or more operations and/or communications of the procedure of FIG. 5 may be performed between an AP device including a sub-10 Ghz AP and an mmWave AP, and a non-AP device including a sub-10 Ghz non-AP STA and an mmWave non-AP STA. For example, controller 124 (FIG. 1) may be configured to control, trigger, and/or cause the AP device implemented by device 102 (FIG. 1) to perform a role of, one or more operations of, and/or one or more functionalities of, the AP device including the sub-10 Ghz AP and the mmWave AP; and/or controller 154 (FIG. 1) may be configured to control, trigger, and/or cause the non-AP device implemented by device 140 (FIG. 1) to perform a role of, one or more operations of, and/or one or more functionalities of, the non-AP device including the sub-10 Ghz non-AP STA and the mmWave non-AP STA.

In some demonstrative aspects, the AP device and the non-AP device may have a link established in a sub-7 GHz band, and may intend to establish a 60 GHz link as well.

In some demonstrative aspects, the AP device and the non-AP device may perform one or more operations configured to trigger 60 GHz discovery and initial beamforming, e.g., as described below.

In some demonstrative aspects, as shown in Fig. 4, the start of the discovery and initial beamforming, e.g., in the 60 GHz band, may be “triggered”, for example, by the AP device, e.g., using a trigger frame 502.

In some demonstrative aspects, the AP device implemented by device 102 (FIG. 1) may be configured to generate and/or transmit the beamforming training trigger frame 502. For example, device 102 (FIG. 1) may be configured to transmit the beamforming training trigger frame 502 from the sub-10 GHz AP of device 102 (FIG. 1) over a sub-10 GHz wireless communication channel.

In some demonstrative aspects, the non-AP device implemented by device 140 (FIG. 1) may be configured to receive and/or process the beamforming training trigger frame 502. For example, device 140 (FIG. 1) may be configured to receive beamforming training trigger frame 502 at the sub-10 GHz non-AP STA of device 140 (FIG. 1) over the sub-10 GHz wireless communication channel.

In some demonstrative aspects, the beamforming training trigger frame 502 may be configured to communicate, e.g., over the sub-7 GHz link, configuration information to configure the beamforming training procedure over a mmWave wireless communication channel, e.g., as described below.

In some demonstrative aspects, the beamforming training trigger frame 502 may be configured to indicate, signal, set and/or negotiate one or more parameters to configure the beamforming training procedure over the mmWave wireless communication channel, e.g., as described below.

In some demonstrative aspects, the configuration information may include a first count value to indicate a count of transmit sectors to be used by device 102 (FIG. 1), and a second count value to indicate a count of training frames per transmit sector.

In some demonstrative aspects, the configuration information may include timing information to indicate a target (planned) sequence start time 503 of a beginning of a sequence of training frames.

In some demonstrative aspects, as shown in FIG. 5, the configuration information may include the number of transmit sectors N, the number of receive sectors M, and/or the planned start time 503.

In some demonstrative aspects, as shown in FIG. 5, device 102 (FIG. 1) may be configured to transmit a sequence of training frames 507 over the mmWave wireless communication channel, for example, after the beamforming training trigger frame 502.

In some demonstrative aspects, as shown in FIG. 5, the mmWave AP of device 102 (FIG. 1) may be attempt to access the mmWave wireless communication channel for transmission of the sequence of training frames 507, for example, at the planned start time 503.

In some demonstrative aspects, as shown in FIG. 5, the AP implemented by device 102 (FIG. 1) may not be able to start transmission of the sequence of training frames 507 at the planned start time 503.

In some demonstrative aspects, as shown in FIG. 5, device 102 (FIG. 1) may begin the sequence of training frames 507 at a delayed sequence start time 511, for example, due to a busy medium 501 at the mmWave wireless communication channel.

In some demonstrative aspects, device 102 (FIG. 1) may be configured to begin transmission of a training frame of the sequence of training frames 507 within a start time margin relative to a target training frame start time.

In some demonstrative aspects, the target training frame start time may be based on the target sequence start time, e.g., the planned start time 503, e.g., as described below.

In some demonstrative aspects, device 102 (FIG. 1) may be configured to begin the sequence of training frames 507 at the delayed sequence start time 511, for example, based on a determination that a start time of the sequence of training frames 507 is to be delayed relative to the target sequence start time, e.g., the planned start time 503.

In one example, the delayed sequence start time 511 may be based on the target sequence start time, e.g., the planned start time 503, a training frame duration, and a start time margin.

In one example, the delayed sequence start time 511 may be based on a sum of the target sequence start time, e.g., the planned start time 503, an integer multiple of a training frame duration, and a start time margin.

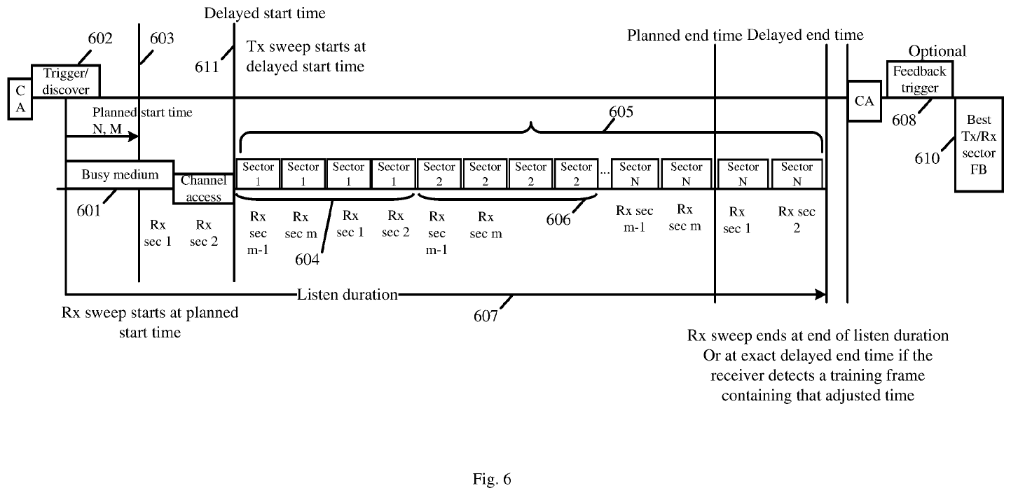

Reference is made to FIG. 6, which schematically illustrates a beamforming training procedure over an mmWave wireless communication channel, in accordance with some demonstrative aspects.

In some demonstrative aspects, as shown in FIG. 6, one or more operations and/or communications of the procedure of FIG. 6 may be performed between an AP device including a sub-10 Ghz AP and an mmWave AP, and a non-AP device including a sub-10 Ghz non-AP STA and an mmWave non-AP STA. For example, controller 124 (FIG. 1) may be configured to control, trigger, and/or cause the AP device implemented by device 102 (FIG. 1) to perform a role of, one or more operations of, and/or one or more functionalities of, the AP device including the sub-10 Ghz AP and the mmWave AP; and/or controller 154 (FIG. 1) may be configured to control, trigger, and/or cause the non-AP device implemented by device 140 (FIG. 1) to perform a role of, one or more operations of, and/or one or more functionalities of, the non-AP device including the sub-10 Ghz non-AP STA and the mmWave non-AP STA.

In some demonstrative aspects, the AP device and the non-AP device may have a link established in a sub-7 GHz band, and may intend to establish a 60 GHz link as well.

In some demonstrative aspects, the AP device and the non-AP device may perform one or more operations configured to trigger 60 GHz discovery and initial beamforming, e.g., as described below.

In some demonstrative aspects, as shown in Fig. 6, the start of the discovery and initial beamforming, e.g., in the 60 GHz band, may be “triggered”, for example, by the AP device, e.g., using a trigger frame 602.

In some demonstrative aspects, the AP device implemented by device 102 (FIG. 1) may be configured to generate and/or transmit the beamforming training trigger frame 602. For example, device 102 (FIG. 1) may be configured to transmit the beamforming training trigger frame 602 from the sub-10 GHz AP of device 102 (FIG. 1) over a sub-10 GHz wireless communication channel.

In some demonstrative aspects, the non-AP device implemented by device 140 (FIG. 1) may be configured to receive and/or process the beamforming training trigger frame 602. For example, device 140 (FIG. 1) may be configured to receive beamforming training trigger frame 602 at the sub-10 GHz non-AP STA of device 140 (FIG. 1) over the sub-10 GHz wireless communication channel.

In some demonstrative aspects, the beamforming training trigger frame 602 may be configured to communicate, e.g., over the sub-7 GHz link, configuration information to configure the beamforming training procedure over a mmWave wireless communication channel, e.g., as described below.

In some demonstrative aspects, the beamforming training trigger frame 602 may be configured to indicate, signal, set and/or negotiate one or more parameters to configure the beamforming training procedure over the mmWave wireless communication channel, e.g., as described below.

In some demonstrative aspects, the configuration information may include a first count value to indicate a count of transmit sectors to be used by device 102 (FIG. 1), and a second count value to indicate a count of training frames per transmit sector.

In some demonstrative aspects, the configuration information may include timing information to indicate a target (planned) sequence start time 603 of a beginning of a sequence of training frames.

In some demonstrative aspects, as shown in FIG. 6, the configuration information may include the number of transmit sectors N, the number of receive sectors M, and/or the planned start time 603.

In some demonstrative aspects, as shown in FIG. 6, device 102 (FIG. 1) may be configured to transmit a sequence of training frames 605 over the mmWave wireless communication channel, for example, after the beamforming training trigger frame 602.

In some demonstrative aspects, as shown in FIG. 6, the mmWave AP of device 102 (FIG. 1) may be attempt to access the mmWave wireless communication channel for transmission of the sequence of training frames 605, for example, at the planned start time 603.

In some demonstrative aspects, as shown in FIG. 6, the AP implemented by device 102 (FIG. 1) may not be able to start transmission of the sequence of training frames 605 at the planned start time 603.

In some demonstrative aspects, as shown in FIG. 6, device 102 (FIG. 1) may begin the sequence of training frames 605 at a delayed sequence start time 611, for example, due to a busy medium 601 at the mmWave wireless communication channel.

In some demonstrative aspects, as shown in FIG. 6, device 102 (FIG. 1) may be configured begin the sequence of training frames 605 with a first-in-order training frame of an ordered training frame sequence, for example, based on a determination that the start time of the sequence of training frames 605 is at the delayed start time 611, which is delayed relative to the target sequence start time 603.

For example, as shown in FIG. 6, device 102 (FIG. 1) may be configured to transmit the sequence of training frames 605 according to the ordered training frame sequence, which was planned for transmission if the sequence of training frames 605 would begin at the target sequence start time 603.

For example, as shown in FIG. 6, device 102 (FIG. 1) may be configured to transmit the sequence of training frames 605 according to the ordered training frame sequence 450 (FIG. 4).

In some demonstrative aspects, as shown in FIG. 6, device 140 (FIG. 1) may be configured to start an Rx beamforming sector sweep at the planned start time 603, and to continue the Rx beamforming sector sweep for listening duration 607.

In some demonstrative aspects, device 140 (FIG. 1) may be configured to operate the mmWave non-AP STA to listen for the sequence of training frames 605 over the mmWave wireless communication channel during the total listening duration 607.

For example, as shown in FIG. 6, the listening duration 607 may be longer than a total duration of the sequence of training frames 605.

For example, the configuration information in trigger frame 602 may include sequence duration information to indicate the total duration of the sequence of training frames 605, e.g., as described above.

In some demonstrative aspects, the configuration information in trigger frame 602 may include listening duration information to indicate the total listening duration 607, for example, during which the non-AP device is to listen for the sequence of training frames 605 over the mmWave wireless communication channel, e.g., as described above.

In some demonstrative aspects, as shown in FIG. 6, device 102 (FIG. 1) may be configured to transmit an optional feedback trigger frame 608 over the sub-10 GHz wireless communication channel, for example, to trigger a feedback frame 610 from device 140 (FIG. 1).

In some demonstrative aspects, device 102 (FIG. 1) may be configured to receive the feedback frame 610 from device 140 (FIG. 1) at the sub-10 GHz AP over the sub-10 GHz wireless communication channel.

In some demonstrative aspects, device 102 (FIG. 1) may be configured to process the feedback frame 610 to identify feedback information, for example, based on the sequence of training frames 605.

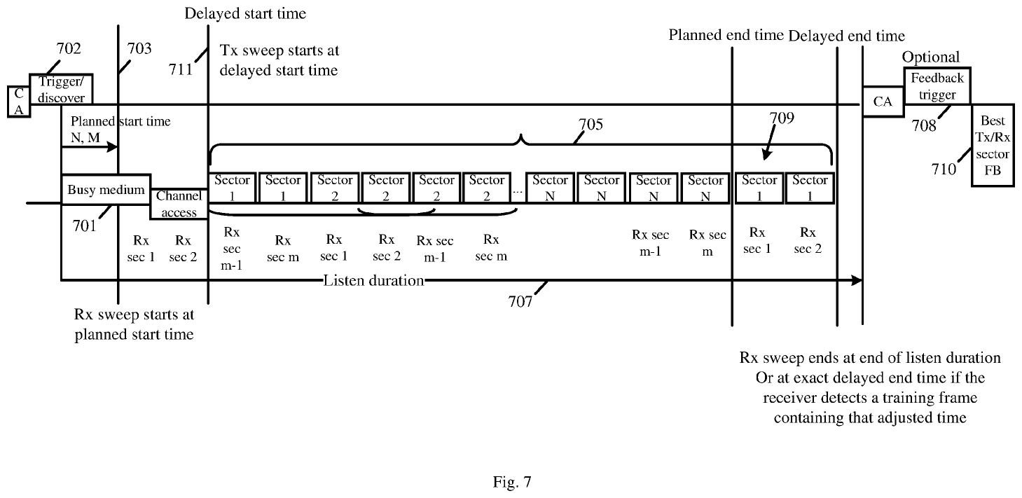

Reference is made to FIG. 7, which schematically illustrates a beamforming training procedure over an mmWave wireless communication channel, in accordance with some demonstrative aspects.

In some demonstrative aspects, as shown in FIG. 7, one or more operations and/or communications of the procedure of FIG. 7 may be performed between an AP device including a sub-10 Ghz AP and an mmWave AP, and a non-AP device including a sub-10 Ghz non-AP STA and an mmWave non-AP STA. For example, controller 124 (FIG. 1) may be configured to control, trigger, and/or cause the AP device implemented by device 102 (FIG. 1) to perform a role of, one or more operations of, and/or one or more functionalities of, the AP device including the sub-10 Ghz AP and the mmWave AP; and/or controller 154 (FIG. 1) may be configured to control, trigger, and/or cause the non-AP device implemented by device 140 (FIG. 1) to perform a role of, one or more operations of, and/or one or more functionalities of, the non-AP device including the sub-10 Ghz non-AP STA and the mmWave non-AP STA.

In some demonstrative aspects, the AP device and the non-AP device may have a link established in a sub-7 GHz band, and may intend to establish a 60 GHz link as well.

In some demonstrative aspects, the AP device and the non-AP device may perform one or more operations configured to trigger 60 GHz discovery and initial beamforming, e.g., as described below.

In some demonstrative aspects, as shown in Fig. 7, the start of the discovery and initial beamforming, e.g., in the 60 GHz band, may be “triggered”, for example, by the AP device, e.g., using a trigger frame 702.

In some demonstrative aspects, the AP device implemented by device 102 (FIG. 1) may be configured to generate and/or transmit the beamforming training trigger frame 702. For example, device 102 (FIG. 1) may be configured to transmit the beamforming training trigger frame 702 from the sub-10 GHz AP of device 102 (FIG. 1) over a sub-10 GHz wireless communication channel.

In some demonstrative aspects, the non-AP device implemented by device 140 (FIG. 1) may be configured to receive and/or process the beamforming training trigger frame 702. For example, device 140 (FIG. 1) may be configured to receive beamforming training trigger frame 702 at the sub-10 GHz non-AP STA of device 140 (FIG. 1) over the sub-10 GHz wireless communication channel.

In some demonstrative aspects, the beamforming training trigger frame 702 may be configured to communicate, e.g., over the sub-7 GHz link, configuration information to configure the beamforming training procedure over a mmWave wireless communication channel, e.g., as described below.

In some demonstrative aspects, the beamforming training trigger frame 702 may be configured to indicate, signal, set and/or negotiate one or more parameters to configure the beamforming training procedure over the mmWave wireless communication channel, e.g., as described below.

In some demonstrative aspects, the configuration information may include a first count value to indicate a count of transmit sectors to be used by device 102 (FIG. 1), and a second count value to indicate a count of training frames per transmit sector.

In some demonstrative aspects, the configuration information may include timing information to indicate a target (planned) sequence start time 703 of a beginning of a sequence of training frames.

In some demonstrative aspects, as shown in FIG. 7, the configuration information may include the number of transmit sectors N, the number of receive sectors M, and/or the planned start time 703.

In some demonstrative aspects, as shown in FIG. 7, device 102 (FIG. 1) may be configured to transmit a sequence of training frames 705 over the mmWave wireless communication channel, for example, after the beamforming training trigger frame 702.

In some demonstrative aspects, as shown in FIG. 7, the mmWave AP of device 102 (FIG. 1) may be attempt to access the mmWave wireless communication channel for transmission of the sequence of training frames 705, for example, at the planned start time 703.

In some demonstrative aspects, as shown in FIG. 7, the AP implemented by device 102 (FIG. 1) may not be able to start transmission of the sequence of training frames 705 at the planned start time 703.

In some demonstrative aspects, as shown in FIG. 7, device 102 (FIG. 1) may begin the sequence of training frames 705 at a delayed sequence start time 711, for example, due to a busy medium 701 at the mmWave wireless communication channel.

In some demonstrative aspects, as shown in FIG. 7, device 102 (FIG. 1) may be configured begin the sequence of training frames 705 with a non-first-in-order training frame of an ordered training frame sequence, for example, based on a determination that the start time of the sequence of training frames 705 is at the delayed start time 711, which is delayed relative to the target sequence start time 703.

For example, as shown in FIG. 7, device 102 (FIG. 1) may be configured to begin the sequence of training frames 705 with a non-first-in-order training frame of the ordered training frame sequence, which was planned for transmission if the sequence of training frames 705 would begin at the target sequence start time 703.

For example, as shown in FIG. 7, device 102 (FIG. 1) may be configured to begin the sequence of training frames 705 with a non-first-in-order training frame of the ordered training frame sequence 450 (FIG. 4).

In some demonstrative aspects, the non-first-in-order training frame may include an (X+1) training frame of the ordered training frame sequence, wherein X denotes a count of training frame durations in the delay period between the target sequence start time 703 and the delayed start time 711.

In some demonstrative aspects, as shown in FIG. 7, device 102 (FIG. 1) may be configured to transmit the X first training frames 709 of the ordered training frame sequence, for example, after transmission of a last training frame of the ordered training frame sequence.

In some demonstrative aspects, as shown in FIG. 7, device 140 (FIG. 1) may be configured to start an Rx beamforming sector sweep at the planned start time 703, and to continue the Rx beamforming sector sweep for listening duration 707.

In some demonstrative aspects, device 140 (FIG. 1) may be configured to operate the mmWave non-AP STA to listen for the sequence of training frames 705 over the mmWave wireless communication channel during the total listening duration 707.

For example, as shown in FIG. 7, the listening duration 707 may be longer than a total duration of the sequence of training frames 705.

For example, the configuration information in trigger frame 702 may include sequence duration information to indicate the total duration of the sequence of training frames 705, e.g., as described above.

In some demonstrative aspects, the configuration information in trigger frame 702 may include listening duration information to indicate the total listening duration 707, for example, during which the non-AP device is to listen for the sequence of training frames 705 over the mmWave wireless communication channel, e.g., as described above.

In some demonstrative aspects, as shown in FIG. 7, device 102 (FIG. 1) may be configured to transmit an optional feedback trigger frame 708 over the sub-10 GHz wireless communication channel, for example, to trigger a feedback frame 710 from device 140 (FIG. 1).

In some demonstrative aspects, device 102 (FIG. 1) may be configured to receive the feedback frame 710 from device 140 (FIG. 1) at the sub-10 GHz AP over the sub-10 GHz wireless communication channel.

In some demonstrative aspects, device 102 (FIG. 1) may be configured to process the feedback frame 710 to identify feedback information, for example, based on the sequence of training frames 705.

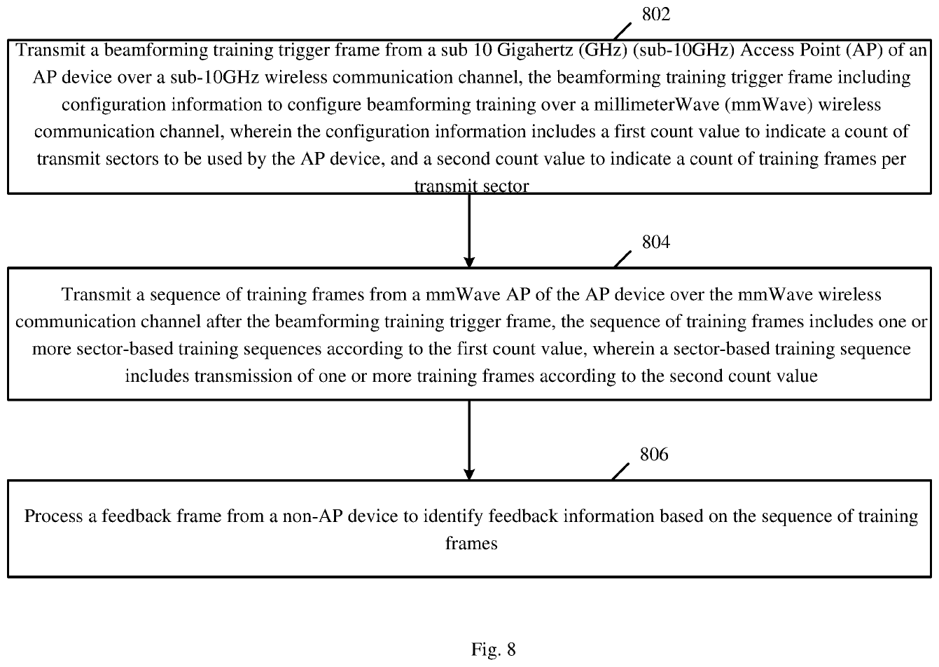

Reference is made to FIG. 8, which schematically illustrates a method of a beamforming training over an mmWave wireless communication channel, in accordance with some demonstrative aspects. For example, one or more of the operations of the method of FIG. 8 may be performed by one or more elements of a system, e.g., system 100 (FIG. 1), for example, one or more wireless devices, e.g., device 102 (FIG. 1), and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 802, the method may include transmitting a beamforming training trigger frame from a sub 10 Gigahertz (GHz) (sub-10 GHz) AP of an AP device over a sub-10 GHz wireless communication channel, the beamforming training trigger frame including configuration information to configure beamforming training over a millimeterWave (mmWave) wireless communication channel, wherein the configuration information includes a first count value to indicate a count of transmit sectors to be used by the AP device, and a second count value to indicate a count of training frames per transmit sector. For example, controller 124 (FIG. 1) may be configured to cause, trigger, and/or control an AP of device 102 (FIG. 1) to transmit the beamforming training trigger frame over the sub-10 GHz wireless communication channel, e.g., as described above.

As indicated at block 804, the method may include transmitting a sequence of training frames from a mmWave AP of the AP device over the mmWave wireless communication channel, for example, after the beamforming training trigger frame, the sequence of training frames including one or more sector-based training sequences according to the first count value, wherein a sector-based training sequence includes transmission of one or more training frames according to the second count value. For example, controller 124 (FIG. 1) may be configured to cause, trigger, and/or control mmWave AP STA 141 (FIG. 1) to transmit the sequence of training frames over the mmWave wireless communication channel, for example, after the beamforming training trigger frame, e.g., as described above.

As indicated at block 806, the method may include processing a feedback frame from a non-AP device to identify feedback information based on the sequence of training frames. For example, controller 124 (FIG. 1) may be configured to cause, trigger, and/or control device 102 (FIG. 1) to process the feedback frame from device 140 (FIG. 1), e.g., as described above.

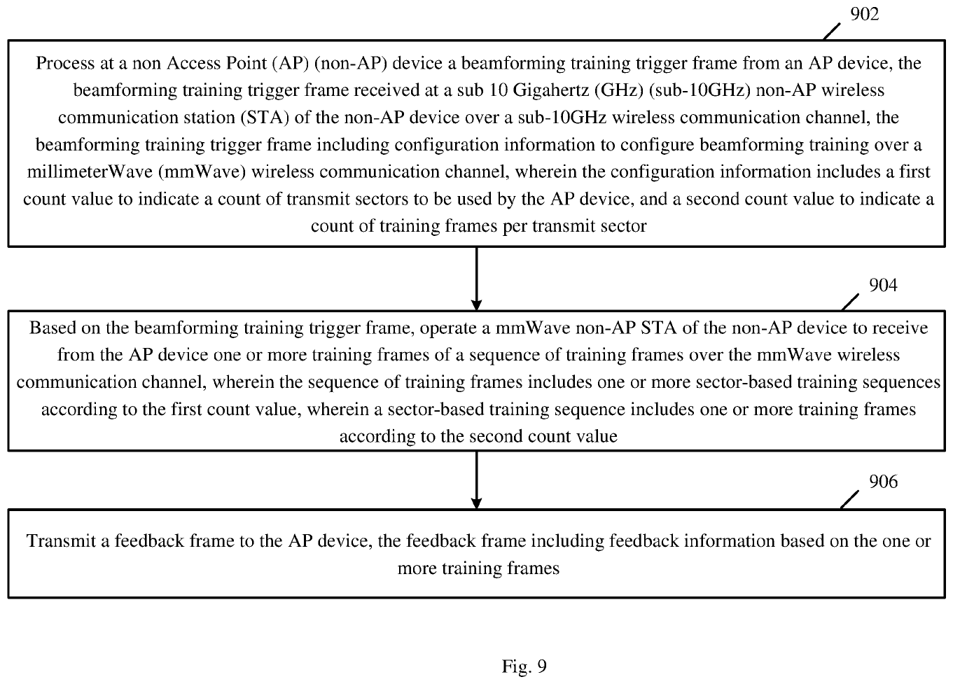

Reference is made to FIG. 9, which schematically illustrates a method of a beamforming training procedure over an mmWave wireless communication channel, in accordance with some demonstrative aspects. For example, one or more of the operations of the method of FIG. 9 may be performed by one or more elements of a system, e.g., system 100 (FIG. 1), for example, one or more wireless devices, e.g., device 102 (FIG. 1), and/or device 140 (FIG. 1), an MLD, e.g., MLD 131 (FIG. 1) and/or

MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 902, the method may include processing at a non-AP device a beamforming training trigger frame from an AP device, the beamforming training trigger frame received at a sub 10 Gigahertz (GHz) (sub-10 GHz) non-AP STA of the non-AP device over a sub-10 GHz wireless communication channel, the beamforming training trigger frame including configuration information to configure beamforming training over a mmWave wireless communication channel, wherein the configuration information includes a first count value to indicate a count of transmit sectors to be used by the AP device, and a second count value to indicate a count of training frames per transmit sector. For example, controller 154 (FIG. 1) may be configured to cause, trigger, and/or control device 140 (FIG. 1) to process the beamforming training trigger frame from device 102 (FIG. 1), which may be received by a sub-10 GHz non-AP STA of device 140 (FIG. 1), e.g., as described above.

As indicated at block 904, the method may include operating a mm Wave non-AP STA of the non-AP device, based on the beamforming training trigger frame, to receive from the AP device one or more training frames of a sequence of training frames over the mmWave wireless communication channel, wherein the sequence of training frames includes one or more sector-based training sequences according to the first count value, wherein a sector-based training sequence includes one or more training frames according to the second count value. For example, controller 154 (FIG. 1) may be configured to cause, trigger, and/or control mmWave STA 161 (FIG. 1) to receive from device 102 (FIG. 1) one or more training frames of the sequence of training frames over the mmWave wireless communication channel, e.g., as described above.

As indicated at block 906, the method may include transmitting a feedback frame to the AP device, the feedback frame including feedback information based on the one or more training frames. For example, controller 154 (FIG. 1) may be configured to cause, trigger, and/or control device 140 (FIG. 1) to transmit the feedback frame to device 102 (FIG. 1), e.g., as described above.

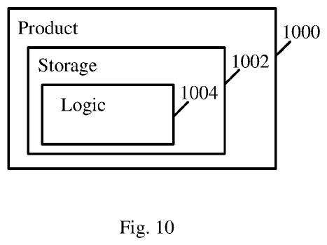

Reference is made to FIG. 10, which schematically illustrates a product of manufacture 1000, in accordance with some demonstrative aspects. Product 1000 may include one or more tangible computer-readable (“machine-readable”) non-transitory storage media 1002, which may include computer-executable instructions, e.g., implemented by logic 1004, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities, and/or to perform, trigger and/or implement one or more operations and/or functionalities described with reference to the FIGS. 1, 2, 3, 4, 5, 6, 7, 8, and/or 9, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1000 and/or machine-readable storage media 1002 may include one or more types of computer-readable storage media capable of storing data, including volatile memory, non-volatile memory, removable or non-removable memory, erasable or non-erasable memory, writeable or re-writeable memory, and the like. For example, machine-readable storage media 1002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause an Access Point (AP) device to transmit a beamforming training trigger frame from a sub 10 Gigahertz (GHz) (sub-10 GHz) AP of the AP device over a sub-10 GHz wireless communication channel, the beamforming training trigger frame comprising configuration information to configure beamforming training over a millimeterWave (mmWave) wireless communication channel, wherein the configuration information comprises a first count value to indicate a count of transmit sectors to be used by the AP device, and a second count value to indicate a count of training frames per transmit sector; transmit a sequence of training frames from a mmWave AP of the AP device over the mmWave wireless communication channel after the beamforming training trigger frame, the sequence of training frames comprises one or more sector-based training sequences according to the first count value, wherein a sector-based training sequence comprises transmission of one or more training frames according to the second count value; and process a feedback frame from a non-AP device to identify feedback information based on the sequence of training frames.

Example 2 includes the subject matter of Example 1, and optionally, wherein the configuration information comprises timing information to indicate a target sequence start time of a beginning of the sequence of training frames.

Example 3 includes the subject matter of Example 2, and optionally, wherein the apparatus is configured to cause the mmWave AP to access the mmWave wireless communication channel for transmission of the sequence of training frames based on the timing information.

Example 4 includes the subject matter of Example 2 or 3, and optionally, wherein the apparatus is configured to cause the mmWave AP to begin transmission of a training frame of the sequence of training frames within a start time margin relative to a target training frame start time, wherein the target training frame start time is based on the target sequence start time.

Example 5 includes the subject matter of any one of Examples 2-4, and optionally, wherein the apparatus is configured to cause the mmWave AP to, based on a determination that a start time of the sequence of training frames is to be delayed relative to the target sequence start time, begin the sequence of training frames at a delayed sequence start time, the delayed sequence start time is based on the target sequence start time, a training frame duration, and a start time margin.

Example 6 includes the subject matter of any one of Examples 2-5, and optionally, wherein the apparatus is configured to cause the mmWave to, based on a determination that a start time of the sequence of training frames is to be delayed relative to the target sequence start time, begin the sequence of training frames at a delayed sequence start time, the delayed sequence start time is based on a sum of the target sequence start time, an integer multiple of a training frame duration, and a start time margin.

Example 7 includes the subject matter of any one of Examples 2-6, and optionally, wherein the apparatus is configured to cause the mmWave AP to, when a start time of the sequence of training frames is at a delayed start time, which is delayed relative to the target sequence start time, begin the sequence of training frames with a first-in-order training frame of an ordered training frame sequence, wherein the ordered training frame sequence is configured for transmission at the target sequence start time.

Example 8 includes the subject matter of any one of Examples 2-6, and optionally, wherein the apparatus is configured to cause the mmWave AP to, based on a determination that a start time of the sequence of training frames is at a delayed start time, which is delayed by a delay period relative to the target sequence start time, begin the sequence of training frames with a non-first-in-order training frame of an ordered training frame sequence, wherein the ordered training frame sequence is configured for transmission at the target sequence start time, wherein the non-first-in-order training frame comprises an (X+1) training frame of the ordered training frame sequence, wherein X denotes a count of training frame durations in the delay period.

Example 9 includes the subject matter of Example 8, and optionally, wherein the apparatus is configured to cause the mmWave AP to transmit X first training frames of the ordered training frame sequence after transmission of a last training frame of the ordered training frame sequence.

Example 10 includes the subject matter of any one of Examples 1-9, and optionally, wherein a training frame of a sector-based training sequence via a transmit sector comprises a sector identifier (ID) to identify the transmit sector.

Example 11 includes the subject matter of any one of Examples 1-10, and optionally, wherein a training frame of the sequence of training frames comprises a target sequence end time to indicate an end time of the sequence of training frames.

Example 12 includes the subject matter of any one of Examples 1-11, and optionally, wherein the second count value is based on a count of receive sectors of the non-AP device.

Example 13 includes the subject matter of any one of Examples 1-12, and optionally, wherein the configuration information comprises sequence duration information to indicate a total duration of the sequence of training frames.

Example 14 includes the subject matter of any one of Examples 1-13, and optionally, wherein the configuration information comprises training frame duration information to indicate a duration of a training frame in the sequence of training frames.

Example 15 includes the subject matter of any one of Examples 1-14, and optionally, wherein the configuration information comprises listening duration information to indicate a total listening duration during which the non-AP device is to listen for the sequence of training frames over the mmWave wireless communication channel.

Example 16 includes the subject matter of Example 15, and optionally, wherein the total listening duration is longer than a total duration of the sequence of training frames.

Example 17 includes the subject matter of any one of Examples 1-16, and optionally, wherein an inter-training frame time interval between consecutive training frames in the sector-based training sequence is based on a sector switching time of the non-AP device.

Example 18 includes the subject matter of any one of Examples 1-17, and optionally, wherein the first count value is greater than one, and the sequence of training frames comprises a plurality of sector-based training sequences, wherein a count of sector-based training sequences in the plurality of sector-based training sequences is equal to the first count value.

Example 19 includes the subject matter of any one of Examples 1-18, and optionally, wherein the second count value is greater than one, and the sector-based training sequence comprises transmission of a plurality of training frames, wherein a count of training frames in the plurality of training frames is equal to the second count value.

Example 20 includes the subject matter of any one of Examples 1-19, and optionally, wherein the feedback frame is received by the sub-10 GHz AP over the sub-10 GHz wireless communication channel.

Example 21 includes the subject matter of any one of Examples 1-20, and optionally, wherein the apparatus is configured to cause the mmWave AP to transmit the sequence of training frames according to a data Physical layer (PHY) mode configured for data communication over the mmWave wireless communication channel.

Example 22 includes the subject matter of Example 21, and optionally, wherein the data PHY mode comprises a Single Carrier (SC) PHY mode, or an Orthogonal Frequency-Division Multiplexing (OFDM) PHY mode.

Example 23 includes the subject matter of Example 21 or 22, and optionally, wherein the data PHY mode comprises a PHY mode utilizing a Modulation and Coding Scheme (MCS) with an MCS index greater than 0.

Example 24 includes the subject matter of any one of Examples 1-23, and optionally, wherein the AP device comprises an AP Multi-Link Device (MLD).

Example 25 includes the subject matter of any one of Examples 1-24, and optionally, wherein the sub-10 GHz wireless communication channel comprises a sub-7 GHz channel.

Example 26 includes the subject matter of any one of Examples 1-25, and optionally, wherein the mmWave wireless communication channel comprises a 60 GHz channel.

Example 27 includes the subject matter of any one of Examples 1-26, and optionally, comprising at least one radio to transmit the beamforming training trigger frame over the sub-10 GHz wireless communication channel, and to transmit the sequence of training frames over the mmWave wireless communication channel.

Example 28 includes the subject matter of Example 27, and optionally, comprising one or more antennas connected to the radio, and a processor to execute instructions of an operating system of the AP device.

Example 29 includes an apparatus comprising logic and circuitry configured to cause a non Access Point (AP) (non-AP) device to process a beamforming training trigger frame from an AP device, the beamforming training trigger frame received at a sub 10 Gigahertz (GHz) (sub-10 GHz) non-AP wireless communication station (STA) of the non-AP device over a sub-10 GHz wireless communication channel, the beamforming training trigger frame comprising configuration information to configure beamforming training over a millimeterWave (mmWave) wireless communication channel, wherein the configuration information comprises a first count value to indicate a count of transmit sectors to be used by the AP device, and a second count value to indicate a count of training frames per transmit sector; based on the beamforming training trigger frame, operate a mm Wave non-AP STA of the non-AP device to receive from the AP device one or more training frames of a sequence of training frames over the mmWave wireless communication channel, wherein the sequence of training frames comprises one or more sector-based training sequences according to the first count value, wherein a sector-based training sequence comprises one or more training frames according to the second count value; and transmit a feedback frame to the AP device, the feedback frame comprising feedback information based on the one or more training frames.

Example 30 includes the subject matter of Example 29, and optionally, wherein the apparatus is configured to cause the non-AP device to sequentially switch between receive sectors of the non-AP device based on the first count value and the second count value.

Example 31 includes the subject matter of Example 29 or 30, and optionally, wherein the apparatus is configured to cause the non-AP device to identify a target sequence start time of a beginning of the sequence of training frames based on timing information in the configuration information, and to begin a receive sector switching sequence between receive sectors of the non-AP device based on the target sequence start time.

Example 32 includes the subject matter of Example 31, and optionally, wherein the apparatus is configured to cause the non-AP device to repeat the receive sector switching sequence based on the first count value.

Example 33 includes the subject matter of any one of Examples 29-32, and optionally, wherein the apparatus is configured to cause the non-AP device to switch from a first receive sector to a second receive sector based on a training frame duration of a training frame in the sequence of training frames.

Example 34 includes the subject matter of any one of Examples 29-33, and optionally, wherein the apparatus is configured to cause the non-AP device to switch from a first receive sector to a second receive sector during an inter-training frame time interval between first and second consecutive training frames of the sequence of training frames.

Example 35 includes the subject matter of any one of Examples 29-34, and optionally, wherein the apparatus is configured to cause the non-AP device to identify a transmit sector of a received training frame based on a sector identifier (ID) in the received training frame.

Example 36 includes the subject matter of any one of Examples 29-35, and optionally, wherein the apparatus is configured to cause the non-AP device to identify an end time of the sequence of training frames based on a target sequence end time in a received training frame.

Example 37 includes the subject matter of any one of Examples 29-36, and optionally, wherein the apparatus is configured to cause the non-AP device to identify a total duration of the sequence of training frames based on sequence duration information in the configuration information.

Example 38 includes the subject matter of any one of Examples 29-37, and optionally, wherein the apparatus is configured to cause the non-AP device to identify a duration of a training frame in the sequence of training frames based on training frame duration information in the configuration information.

Example 39 includes the subject matter of any one of Examples 29-38, and optionally, wherein the apparatus is configured to cause the non-AP device to identify a total listening duration based on listening duration information in the configuration information, and to operate the mmWave non-AP STA to listen for the sequence of training frames over the mmWave wireless communication channel during the total listening duration.

Example 40 includes the subject matter of Example 39, and optionally, wherein the total listening duration is longer than a total duration of the sequence of training frames.

Example 41 includes the subject matter of any one of Examples 29-40, and optionally, wherein the second count value is based on a count of receive sectors of the non-AP device.

Example 42 includes the subject matter of any one of Examples 29-41, and optionally, wherein the first count value is greater than one, and the sequence of training frames comprises a plurality of sector-based training sequences, wherein a count of sector-based training sequences in the plurality of sector-based training sequences is equal to the first count value.

Example 43 includes the subject matter of any one of Examples 29-42, and optionally, wherein the second count value is greater than one, and the sector-based training sequence comprises a plurality of training frames, wherein a count of training frames in the plurality of training frames is equal to the second count value.

Example 44 includes the subject matter of any one of Examples 29-43, and optionally, wherein the apparatus is configured to cause the sub-10 Ghz non-AP STA to transmit the feedback frame to the AP device over the sub-10 GHz wireless communication channel.

Example 45 includes the subject matter of any one of Examples 29-44, and optionally, wherein the apparatus is configured to cause the mmWave non-AP STA to process the sequence of training frames according to a data Physical layer (PHY) mode configured for data communication over the mmWave wireless communication channel.

Example 46 includes the subject matter of Example 45, and optionally, wherein the data PHY mode comprises a Single Carrier (SC) PHY mode, or an Orthogonal Frequency-Division Multiplexing (OFDM) PHY mode.

Example 47 includes the subject matter of Example 45 or 46, and optionally, wherein the data PHY mode comprises a PHY mode utilizing a Modulation and Coding Scheme (MCS) with an MCS index greater than 0.

Example 48 includes the subject matter of any one of Examples 29-47, and optionally, wherein the non-AP device comprises a non-AP Multi-Link Device (MLD).

Example 49 includes the subject matter of any one of Examples 29-48, and optionally, wherein the sub-10 GHz wireless communication channel comprises a sub-7 GHz channel.

Example 50 includes the subject matter of any one of Examples 29-49, and optionally, wherein the mmWave wireless communication channel comprises a 60 GHz channel.

Example 51 includes the subject matter of any one of Examples 29-50, and optionally, comprising at least one radio to receive the beamforming training trigger frame over the sub-10 GHz wireless communication channel, and to receive the sequence of training frames over the mmWave wireless communication channel.

Example 52 includes the subject matter of Example 51, and optionally, comprising one or more antennas connected to the radio, and a processor to execute instructions of an operating system of the non-AP device.

Example 53 comprises a wireless communication device comprising the apparatus of any of Examples 1-52.

Example 54 comprises an apparatus comprising means for executing any of the described operations of any of Examples 1-52.

Example 55 comprises a product comprising one or more tangible computer-readable non-transitory storage media comprising computer-executable instructions operable to, when executed by at least one processor, enable the at least one processor to cause a wireless communication device to perform any of the described operations of any of Examples 1-52.

Example 56 comprises an apparatus comprising: a memory interface; and processing circuitry configured to: perform any of the described operations of any of Examples 1-52.

Example 57 comprises a method comprising any of the described operations of any of Examples 1-52.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1-25. (canceled)

26. An apparatus comprising logic and circuitry configured to cause an Access Point (AP) device to:
transmit a beamforming training trigger frame from a sub 10 Gigahertz (GHz) (sub-10 GHz) AP of the AP device over a sub-10 GHz wireless communication channel, the beamforming training trigger frame comprising configuration information to configure beamforming training over a millimeterWave (mmWave) wireless communication channel, wherein the configuration information comprises a first count value to indicate a count of transmit sectors to be used by the AP device, and a second count value to indicate a count of training frames per transmit sector;
transmit a sequence of training frames from a mmWave AP of the AP device over the mmWave wireless communication channel after the beamforming training trigger frame, the sequence of training frames comprises one or more sector-based training sequences according to the first count value, wherein a sector-based training sequence comprises transmission of one or more training frames according to the second count value; and
process a feedback frame from a non-AP device to identify feedback information based on the sequence of training frames.

27. The apparatus of claim 26, wherein the configuration information comprises timing information to indicate a target sequence start time of a beginning of the sequence of training frames.

28. The apparatus of claim 27 configured to cause the mmWave AP to begin transmission of a training frame of the sequence of training frames within a start time margin relative to a target training frame start time, wherein the target training frame start time is based on the target sequence start time.

29. The apparatus of claim 27 configured to cause the mmWave AP to, based on a determination that a start time of the sequence of training frames is to be delayed relative to the target sequence start time, begin the sequence of training frames at a delayed sequence start time, the delayed sequence start time is based on the target sequence start time, a training frame duration, and a start time margin.

30. The apparatus of claim 27 configured to cause the mmWave to, based on a determination that a start time of the sequence of training frames is to be delayed relative to the target sequence start time, begin the sequence of training frames at a delayed sequence start time, the delayed sequence start time is based on a sum of the target sequence start time, an integer multiple of a training frame duration, and a start time margin.

31. The apparatus of claim 27 configured to cause the mmWave AP to, when a start time of the sequence of training frames is at a delayed start time, which is delayed relative to the target sequence start time, begin the sequence of training frames with a first-in-order training frame of an ordered training frame sequence, wherein the ordered training frame sequence is configured for transmission at the target sequence start time.

32. The apparatus of claim 27 configured to cause the mmWave AP to, based on a determination that a start time of the sequence of training frames is at a delayed start time, which is delayed by a delay period relative to the target sequence start time, begin the sequence of training frames with a non-first-in-order training frame of an ordered training frame sequence, wherein the ordered training frame sequence is configured for transmission at the target sequence start time, wherein the non-first-in-order training frame comprises an (X+1) training frame of the ordered training frame sequence, wherein X denotes a count of training frame durations in the delay period.

33. The apparatus of claim 26, wherein a training frame of a sector-based training sequence via a transmit sector comprises a sector identifier (ID) to identify the transmit sector.

34. The apparatus of claim 26, wherein a training frame of the sequence of training frames comprises a target sequence end time to indicate an end time of the sequence of training frames.

35. The apparatus of claim 26, wherein the second count value is based on a count of receive sectors of the non-AP device.

36. The apparatus of claim 26, wherein the configuration information comprises sequence duration information to indicate a total duration of the sequence of training frames.

37. The apparatus of claim 26, wherein the configuration information comprises training frame duration information to indicate a duration of a training frame in the sequence of training frames.

38. The apparatus of claim 26, wherein the configuration information comprises listening duration information to indicate a total listening duration during which the non-AP device is to listen for the sequence of training frames over the mmWave wireless communication channel.

39. The apparatus of claim 26, wherein an inter-training frame time interval between consecutive training frames in the sector-based training sequence is based on a sector switching time of the non-AP device.

40. The apparatus of claim 26, wherein the first count value is greater than one, and the sequence of training frames comprises a plurality of sector-based training sequences, wherein a count of sector-based training sequences in the plurality of sector-based training sequences is equal to the first count value.

41. The apparatus of claim 26, wherein the second count value is greater than one, and the sector-based training sequence comprises transmission of a plurality of training frames, wherein a count of training frames in the plurality of training frames is equal to the second count value.

42. The apparatus of claim 26 comprising at least one radio to transmit the beamforming training trigger frame over the sub-10 GHz wireless communication channel, and to transmit the sequence of training frames over the mmWave wireless communication channel.

43. The apparatus of claim 42 comprising one or more antennas connected to the radio, and a processor to execute instructions of an operating system of the AP device.

44. A product comprising one or more tangible computer-readable non-transitory storage media comprising instructions operable to, when executed by at least one processor, enable the at least one processor to cause an Access Point (AP) device to:
transmit a beamforming training trigger frame from a sub 10 Gigahertz (GHz) (sub-10 GHz) AP of the AP device over a sub-10 GHz wireless communication channel, the beamforming training trigger frame comprising configuration information to configure beamforming training over a millimeterWave (mmWave) wireless communication channel, wherein the configuration information comprises a first count value to indicate a count of transmit sectors to be used by the AP device, and a second count value to indicate a count of training frames per transmit sector;
transmit a sequence of training frames from a mmWave AP of the AP device over the mmWave wireless communication channel after the beamforming training trigger frame, the sequence of training frames comprises one or more sector-based training sequences according to the first count value, wherein a sector-based training sequence comprises transmission of one or more training frames according to the second count value; and
process a feedback frame from a non-AP device to identify feedback information based on the sequence of training frames.

45. The product of claim 44, wherein the configuration information comprises timing information to indicate a target sequence start time of a beginning of the sequence of training frames.
